(19) United States
(12) Patent Application Publication
(10) Pub. No.: US 2002/0147739 A1
(43) Pub. Date: Oct. 10, 2002

(54) Methods and systems for tracking storage resources associated with a document distribution system

(75) Inventors: Bradley H. Clements, Cedar Hills, UT (US); John A. Ford, Orem, UT (US)

Correspondence Address: Gregory M. Taylor, WORKMAN, NYDEGGER & SEELEY, 1000 Eagle Gate Tower, 60 East South Temple, Salt Lake City, UT, 84111, US

(73) Assignee: NetVoyage Corporation

(21) Appl. No.: 09/829,899

(22) Filed: Apr. 10, 2001

(51) Int. Cl. G06F 17/60

(52) U.S. Cl. 707/500

(57) ABSTRACT

A method for tracking the allocation of resources within a document storage repository containing a user account having a user storage total and a document distributor account having a document distributor storage total. The method can include identifying a user account containing a document, the document having an attribute that defines an author of the document as a document distributor or a general user, and a storage amount defining the amount of the document storage repository used by the document. The document can be analyzed to determine whether the attribute defines the author of the document as either a document distributor or a general user. In the event that the document distributor is the author, the storage amount associated with the document is excluded from a user storage total and included in the storage total of the document distributor.

### BACKGROUND OF THE INVENTION

1. Field of the Invention

The present invention relates to the storage of data with a document storage repository. More specifically, the present invention relates to methods and systems by which storage resources are tracked and allocated between one or more users that have an account or storage space within the document storage repository.

2. Background Technology

Almost since the inception of the computer, users have interacted and performed useful work on a computer through specialized programs designed to perform various tasks. These specialized programs, often referred to as application programs, allow users to perform desired tasks such as word processing, spreadsheet creation, data entry, and so forth. When a user wishes to perform a certain task, the user starts the execution of an application program and performs all interaction with the computer through the application program. For instance, when a user wishes to create a word processing document, the user initiates execution of the word processing program and creates or edits the word processing document through the word processing program. Once a document is created or edited the document can be saved for later retrieval, such as upon a hard disk, a removable magnetic disk, or the like.

With advances in the Internet and the increased connectivity of computers throughout the world, storage of documents created by different application programs has become an important concern to individuals and businesses a like. For instance, in today's business environment, several individuals may need to collaboratively work on a given project at the same time. This is the case even if the numerous individuals are in different buildings, states, or countries.

As the scope and connectivity of the Internet increases, businesses have attempted to harness the increased connectivity and simplicity of communication achievable through the Internet to become “connected” with individuals using their services and products. For instance, many banks provide online banking services, while some businesses provide online shopping or purchasing. The expansive characteristics of the Internet provide the possibility for “paperless” communication between businesses and their customers, resulting in the potential for reduced costs and an increased number of services that can be provided. Unfortunately, to create such a “paperless” world, large data storages are need that can be easily accessed by multiple individuals.

In an attempt to provide the necessary connectivity and storage capabilities required by individuals, and more so businesses, various systems have been developed to store data, while providing multi-user access to such data. For instance, one such system is disclosed in U.S. Pat. No. 6,182,080 B1, entitled “System, Method and Computer Program Product for Storage of a Plurality of Documents within a Single File,” the disclosure of which is incorporated herein by reference. This system provides a mechanism whereby a single file, termed a container file, is stored at a central data repository. Multiple documents or files are stored within the container file, no matter the type of application program needed to “open” or access the document. Each container file can include attributes that define those individuals that can access, read, write, or otherwise manipulate the data stored therein. Consequently, an owner of a container file can provide access to the container file, or individual documents within the container file, whether or not the individual accessing the document or file is in the same building, state or country. Other storage systems have been developed to allow individuals and businesses to create a central data repository that is accessible by multiple users.

Unfortunately, there remain a number of problems with existing document storage repositories. An important aspect of the various data repository type systems is the manner by which data storage resources are allocated and tracked. Typically, data repository providers set an upper limit to the amount of data that can be stored within an individual or business data store or storage space, e.g., ten megabytes. Each user, whether individual or business, pays the data repository provider a defined sum of money per the account owned or the amount of storage used by the individual or business. Consequently, each user can store any number of documents, whether word processing, spreadsheet, graphics, and the like, up to the limit of the data storage or user account. Some other data repository providers track the amount of data storage used at a defined time, e.g., a provider checks the number of documents stored within a user's data storage on a weekly or monthly basis.

No matter which technique is used, each document within the user's data store or account is tracked and included in the user's storage total. This is true even if the user does not desire the documents received and stored within the user's data store. For instance, assuming that the user has a ten megabyte data store, in the event that the user receives a one megabyte advertisement from some other user, such as an advertisement distributor, the available space within which the user can store other documents is reduced by one megabyte to nine megabytes. In the event that the user receives nine additional advertisements from the same or other advertisement distributors, each being one megabyte in size, the user's data storage total is ten megabytes. The user, therefore, is unable to store any additional documents until one or more of the advertisements is deleted or the size of the user's data store is increased. Further, if receipt of such advertisements occurs within the usage calculation period, the user will be charged for the use of ten megabytes of space, while the user does not use any of the data space for documents they wish to access or store.

It would therefore be an advance to provide a document storage repository that is configured to accommodate the delivery of certain types of documents to different users without the storage of the document affecting the overall storage totals for the recipient user.

### SUMMARY AND OBJECTS OF THE INVENTION

It is an object of the present invention to provide methods and systems where the resources used by one user are allocated to another user.

Another object of the present invention is to provide methods and systems where resources utilized by a user to store a document within the user's account are allocated to the author of the stored document instead of the user storing the document.

It is yet another object of the present invention to provide methods and systems for identifying the authorship of a document and/or container file stored within a user's account.

Still another object of the present invention is to provide methods and systems where a document distributor can deliver documents to various users without the need for the document distributor to deliver the document via a delivery container file.

It is another object of the present invention to provide methods and systems where a user can create documents and store the same within a container file and optionally allow multiple users to access the created document.

Yet another object of the present invention is to provide methods and systems where resources are allocated to a document distributor based upon the number of documents that the document distributor delivers to one or more users.

Still another object of the present invention is to provide methods and systems where resources are allocated to a document distributor based upon the amount of storage utilized by those documents stored within user accounts that are authored by the document distributor.

As discussed above, many existing document storage repositories are capable of storing amounts of data. These document storage repositories allow a resource for multiple users to store and access documents. Unfortunately, current document storage repositories are incapable of selectively calculating the resources utilized by each user, where the usage by some users is allocated to some other user. It would, however, be desirable if a document storage repository could shift resource usage from one user to another user based upon the data or information stored within a user's account. To overcome the currently existing limitations to allocation of resources between different users, the present invention disclosed herein provides systems and methods for tracking the allocation of resources within a document storage repository, where certain amounts of a user's storage total is shifted or applied to the storage total of another user.

According to one aspect, the present invention includes a document storage repository having one or more user accounts. Each user account provides a storage space where a user can store documents, whether as a stand-alone document or within a container file. The user accounts can include a number of attributes and/or properties that define various characteristics of the user account and the owner of such an account. For instance, the user account can include attributes that define the user's name, address, electronic mail address, or the like. Further, an attribute or other identifier can designate a user as a document distributor.

These document distributors can distribute a large number of documents to multiple users, however the storage used by such documents is allocated to the document distributor and not to the recipient of the document. Consequently, the present invention provides a mechanism whereby documents created by document distributors and subsequently shared with or delivered to other users are not counted towards the storage totals of the recipients. Instead, the document distributors are allocated the resources used by the documents they deliver. This is true whether or not the document distributor delivers or shares a single document or a container file that includes one or more documents.

The container file represents a single storage file within which a variety of different documents can be stored. One or more data fields within the document storage repository can represent this storage file. The container file can simultaneously store documents that are accessible by a word processing application, a spreadsheet application, a graphics application, or the like. The term “container file” defines a number of different types of storage files, including a sharing container file that can be used to share one or more documents between multiple users, a delivering container file that can be used to deliver one or more documents from one user to another, or the like.

As mentioned above, each user account can include numerous attributes and properties. Similarly, each document and container file can includes attributes and properties that identify certain characteristics of the document and container file. Each of the attributes and/or properties for the user accounts, documents, and container files can be included within one or more data fields. Accordingly, each document and container file can include, but is not limited to, a name attribute, a date created attribute, a date modified attribute, an access list, an author attribute, and optionally a “free storage” attribute, optionally contained within one or more data fields. Whenever the document or the container file is created by a document distributor, i.e., a user with a specified value or pointer to some other attribute, the free storage attribute is added to the document or container file attributes indicating that it was created by the document distributor. This free storage attribute is affixed whether the document is created manually through a user interface or via an automated process using an appropriate application program interface (API) associated with the document storage repository. This free storage attribute remains with the document or container file even if the document or container file is transferred to another user account or shared with another account.

Alternatively, an author attribute of the document and container file can point to the user attributes of the author of the document and container file, and more specifically, to a document distributor attribute that identifies the user as a document distributor or a general user.

According to another aspect of the present invention, each time a document or container file is created by a document distributor, a transaction is written to a log stored at the document storage repository. This log tracks substantially all actions taken by each user and the number and/or size of the documents and/or container files delivered or shared by the document distributor and other users. In one configuration of the present invention, such data stored within the log can be stored as one or more data fields and imported into a billing system to compute charges for the document distributor and other users. Further, the document storage repository can use the log to compute a user's storage total, while optionally analyzing the document distributor attributes for each user, document, and/or container file, and/or each free storage attribute to exclude certain documents and/or container files from one user and include the same documents and/or container files in the total for an associated document distributor. The resultant determination of where documents and/or container files are to be associated can optionally be stored in one or more data fields accessible by various modules or components of the document storage repository.

These and other features of the present invention will become more fully apparent from the following description and appended claims, or can be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof that are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates an exemplary system that provides a suitable operating environment for the present invention;

FIG. 2 is a top level diagram illustrating another exemplary system that provides a suitable operating environment for the present invention;

FIG. 3 is more detailed representation of the top level diagram of FIG. 2 illustrating one embodiment of the present invention;

FIG. 4 is a diagram illustrating a structured storage of one embodiment of the present invention;

FIG. 5 is a flow diagram representing a method for uploading a document into the structured storage of one embodiment of the present invention;

FIG. 6 is a schematic representation of the transfer and retrieval of data from various modules of the structured storage of one embodiment of the present invention;

FIG. 7 is a flow diagram representing a method for calculating resource allocation of data within the structured storage of one embodiment of the present invention;

FIG. 8 is a flow diagram representing another method for calculating resource allocation of data within the structured storage of one embodiment of the present invention; and

FIG. 9 is a flow diagram representing a method for calculating resource allocation of data within the structured storage of one embodiment of the present invention and creating a billing statement based upon the calculated resource allocation.

### DETAILED DESCRIPTION OF THE INVENTION

The present invention extends to both methods and systems for tracking the allocation of resources within a document storage repository. Through tracking storage resource usage, the present invention can identify the amount of storage space utilized by each user, i.e., identify the size and number of documents and/or files accessible to a particular user. In addition, the present invention facilitates analysis of each file or document to identify the author or creator of the file or document. Consequently, the present invention tracks whether a specialized user, termed a “document distributor” authored the stored files or documents, and based upon the tracked information, the present invention can accurately calculate the allocation of storage resources for each user and optionally calculate costs associated with the storage resources used by each user.

The embodiments of the present invention can comprise a special purpose or general-purpose computer that includes computer hardware, as discussed in greater detail below. Embodiments within the scope of the present invention also include computer-readable media for carrying or having computer-executable instructions or data structures, including one or more data fields, stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of computer-executable instructions or data structures and that can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data, optionally stored in data fields, which cause a general purpose computer, special purpose computer, or special purpose processing device to perform a certain function or group of functions.

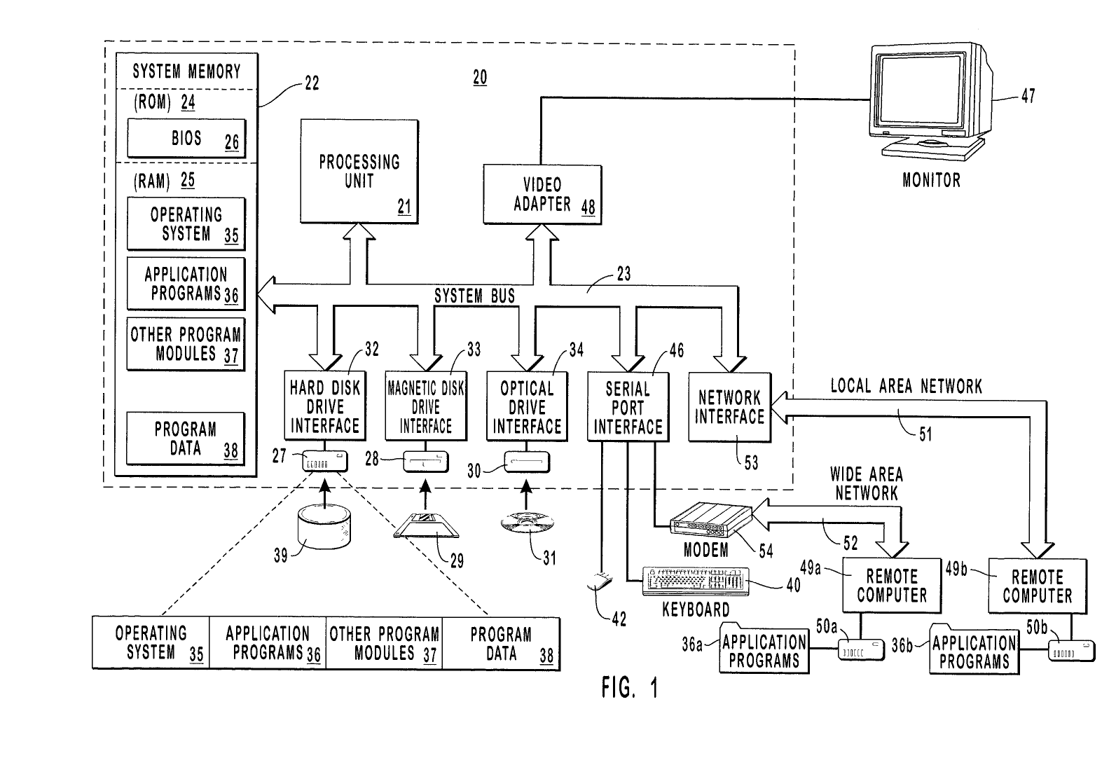

FIG. 1 and the following discussion are intended to provide a brief, general description of a suitable computing environment in which the invention can be implemented. Although not required, the invention will be described in the general context of computer-executable instructions, such as program modules, being executed by computers in network environments. Generally, program modules include routines, programs, objects, components, data structures, including data fields, etc. that perform particular tasks or implement particular abstract data types. Computer-executable instructions, associated data structures, and program modules represent examples of the program code means for executing steps of the methods disclosed herein. The particular sequence of such executable instructions or associated data structures, optionally including one or more data fields, represents examples of corresponding acts for implementing the functions described in such steps.

Those skilled in the art will appreciate that the invention can be practiced in network computing environments with many types of computer system configurations, including personal computers, hand-held devices, multi-processor systems, microprocessor-based or programmable consumer electronics, network PCs, minicomputers, mainframe computers, and the like. The invention can also be practiced in distributed computing environments where tasks can be performed by local and remote processing devices that are linked (either by hardwired links, wireless links, or by a combination of hardwired or wireless links) through a communications network. In a distributed computing environment, program modules can be located in both local and remote memory storage devices.

With reference to FIG. 1, an exemplary system for implementing the invention includes a general-purpose computing device in the form of a conventional computer 20, including a processing unit 21, a system memory 22, and a system bus 23 that couples various system components including the system memory 22 to the processing unit 21. The system bus 23 can be any of several types of bus structures including a memory bus or memory controller, a peripheral bus, and a local bus using any of a variety of bus architectures. The system memory includes read only memory (ROM) 24 and random access memory (RAM) 25. A basic input/output system (BIOS) 26, containing the basic routines that help transfer information between elements within the computer 20, such as during start-up, can be stored in ROM 24.

The computer 20 can also include a magnetic hard disk drive 27 for reading from and writing to a magnetic hard disk 39, a magnetic disk drive 28 for reading from or writing to a removable magnetic disk 29, and an optical disk drive 30 for reading from or writing to removable optical disk 31 such as a CD-ROM or other optical media. The magnetic hard disk drive 27, magnetic disk drive 28, and optical disk drive 30 are connected to the system bus 23 by a hard disk drive interface 32, a magnetic disk drive-interface 33, and an optical drive interface 34, respectively. The drives and their associated computer-readable media provide nonvolatile storage of computer-executable instructions, data structures, program modules and other data for the computer 20. Although the exemplary environment described herein employs a magnetic hard disk 39, a removable magnetic disk 29 and a removable optical disk 31, other types of computer readable media for storing data can be used, including magnetic cassettes, flash memory cards, digital versatile disks (DVDs), Bernoulli cartridges, RAMs, ROMs, and the like.

Program code means comprising one or more program modules can be stored on the hard disk 39, magnetic disk 29, optical disk 31, ROM 24 or RAM 25, including an operating system 35, one or more application programs 36, other program modules 37, and program data 38. A user can enter commands and information into the computer 20 through keyboard 40, pointing device 42, or other input devices (not shown), such as a microphone, joy stick, game pad, satellite dish, scanner, or the like. These and other input devices are often connected to the processing unit 21 through a serial port interface 46 coupled to system bus 23. Alternatively, the input devices can be connected by other interfaces, such as a parallel port, a game port or a universal serial bus (USB). A monitor 47 or another display device is also connected to system bus 23 via an interface, such as video adapter 48. In addition to the monitor, personal computers typically include other peripheral output devices (not shown), such as speakers and printers.

The computer 20 can operate in a networked environment using logical connections to one or more remote computers, such as remote computers 49a and 49b. Remote computers 49a and 49b can each be another personal computer, a server, a router, a network PC, a peer device or other common network node, and typically include many or all of the elements described above relative to the computer 20, although only memory storage devices 50a and 50b and their associated application programs 36a and 36b have been illustrated in FIG. 1. The logical connections depicted in FIG. 1 include a local area network (LAN) 51 and a wide area network (WAN) 52 that are presented here by way of example and not limitation. Such networking environments are commonplace in office-wide or enterprise-wide computer networks, intranets and the Internet.

When used in a LAN networking environment, the computer 20 is connected to the local network 51 through a network interface or adapter 53. When used in a WAN networking environment, the computer 20 can include a modem 54, a wireless link, or other means for establishing communications over the wide area network 52, such as the Internet. The modem 54, which can be internal or external, is connected to the system bus 23 via the serial port interface 46. In a networked environment, program modules depicted relative to the computer 20, or portions thereof, can be stored in the remote memory storage device. It will be appreciated that the network connections shown are exemplary and other means of establishing communications over wide area network 52 can be used.

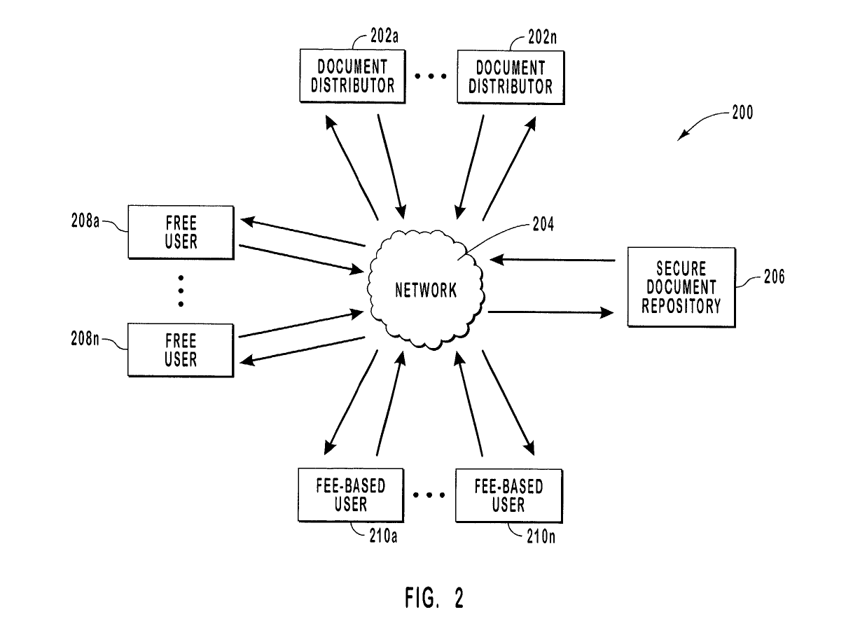

Referring now to FIG. 2, depicted is a schematic representation of one illustrative network system 200 within which the methods and systems of the present invention can be incorporated. The system 200 facilitates the storage of documents and other information in files that can be easily exchanged and used by individuals or groups of individuals. For example, a single file can contain multiple different documents that use different application programs to open or access the contents of the documents. These documents and other information can be stored in a single file that can be referred to as a container file. One illustrative configuration of such a container file and a system within which such a container file can be used is described in U.S. Pat. No. 6,182,080 B1 to Clements (hereinafter the “Clements patent”), which is incorporated herein by reference.

Although it is preferred that each container file and system 200 have a configuration similar to that described in the Clements patent, it will be appreciated by one skilled in the art that various other systems are applicable in performing the functions described herein in light of the teachings contained herein.

The system 200 can include one or more document distributors 202a-202n that communicate via network 204 with a secure document storage repository 206. Further, numerous free users 208a-208n and fee-based users 210a-210n can communicate with or access document storage repository 206 via network 204. In this manner, various users can access document storage repository 206 from numerous different remote or local locations via network 204, such as a WAN, a LAN, a wireless network, a packetized network, and the like.

Generally, document distributors 202a-202n are a specialized type of user that wishes to distribute documents to one or more of the users having an account with document storage repository 206, such as free users 208a-208n and fee-based users 210a-210n, while limiting or substantially eliminating any increase in the storage totals of those users that receive the document distributors'correspondence. Stated another way, each document distributor wishes to send correspondence to free users 208a-208n and fee-based users 210a-210n with the knowledge that the size of the correspondence, i.e., the number of bytes forming the correspondence, will not be subtracted from the user's account or will not be counted against the user when the user's data storage total is calculated. Typically, document distributors can include brokers, utility companies, and the like that wish to send mass mailings, statements, advertisements, and other information to one or multiple individuals having an account with document storage repository 206.

In contrast to each document distributor 202a-202n, each free user 208a-208n is considered a general user of document storage repository 206. Consequently, each free user 208a-208n is provided with a defined storage space, e.g., from about one megabyte to about ten megabytes, within which each free user 208a-208n can store various documents whether as stand alone documents or as part of or included with a stored container file. As the name suggests, each free user 208a-208n is provided with a designated storage space at no cost. In the event that a free user 208a-208n exceeds the allotted amount of storage space, the free user 208a-208n can switch to being a fee-based user 210a-210n where the user has to pay for the amount of storage used in excess of the allotted storage space associated with being a free user 208a-208n. Alternatively, a free user 208a-208n may be charged the fee associated with a fee-based user 210a-210n without prorating for the amount of storage in excess of the designated free user allotted storage space.

As may be understood from the above, each fee-based user 210a-210n pays a particular fee for use of a designated amount of storage space that is typically greater than the storage space provided to a free user 208a-208n. Optionally, each fee-based user 210a-210n can have access to an unlimited amount of space, so long as the provider of document storage repository 206 believes that a fee-based user 210a-210n is capable of paying the appropriate fee.

As used herein and understood by one skilled in the art, the term “user” includes document distributors 202a-202n, free users 208a-208n, and fee-based users 210a-210n. More generally, the term “user” can refer to and include any individual or entity that can access or communicate with document storage repository 206, have an account with document storage repository 206, or otherwise be able to store, retrieve, manipulate, or exploit documents and/or container files stored at document storage repository 206. For example, each user can take the form of an individual operating a workstation, such as computer 20 described above, which can connect with network 204 and enable access to document storage repository 206 and the container files and documents stored therein. Alternatively, each user can take the form of an individual server and/or client or multiple servers and/or clients that access document storage repository 206. In such a case, the servers and/or clients can use an application program interface (API) to directly communicate with document storage repository 206 and the stored container files and documents.

Generally, document storage repository 206 includes data storage modules upon which data created by the users can be stored as stand alone documents or as part of one or more container files. Further, document storage repository 206 provides a structured environment for storing and retrieving documents. The document storage repository 206 can include a plurality of servers that communicate one with another and store data and other information on hard disks, magnetically readable media, optically read media, and the like. Such servers can be local one to another or remotely located but accessible one to another.

In addition to the modules described above, document storage repository 206 can include software applications to provide a graphical user interface (GUI) that facilitates access to the data stored in document storage repository 206. This GUI, such as a web site, can let users create a user account specific and unique to the particular user. Consequently, the GUI can assist an individual to become a free user 208a-208n, a fee-based user 210a-210n or a document distributor 202a-202n with the associated rights and properties. As mentioned above, a free user may be limited in the amount of data that they can store in document storage repository 206, while a fee-based user may be capable of storing a larger amount of data or an unlimited amount of data if they are capable of paying for their storage requirements. Similarly, a document distributor may have an unlimited quantity of storage space within document storage repository 206 and may optionally receive a discounted rate for the storage used or that the document distributor is expected to use. In this manner, document storage repository 206 can store user data, while providing an appropriate GUI to facilitate access to the data stored therein.

Further, the software associated with document storage repository 206 can facilitate sharing and delivering of documents and container files between the various users having an account with document storage repository 206. For example, one document distributor 202a-202n can store a single document or a group of documents in a container file accessible by a single user. Alternatively, document distributor 202a-202n can store single or multiple documents in a container file accessible by multiple users, such as a shared container file. Optionally, the documents can be delivered from one user to another user through the use of a delivery container file. Although reference is made to the actions of document distributor 202a-202n, it will be understood that any user can share, deliver, and store documents in container files or as stand alone documents. Further, each of the above container files can be considered as separate files and therefore, the discussion herein will use the phrase “container file” as representing a storage container file, a delivery container file, and/or a shared container file.

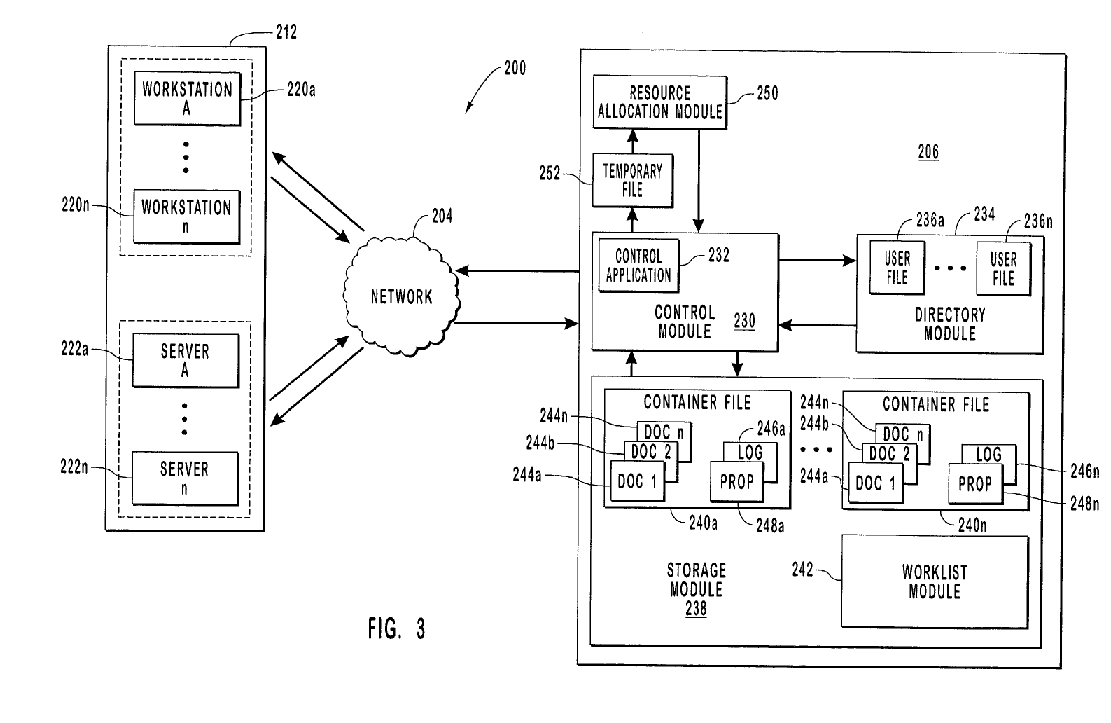

Turning now to FIG. 3, a more detailed schematic representation of system 200 is depicted. Specifically, various users, i.e., document distributors 202a-202n, free users 208a-208n, and fee-based users 210a-210n are represented collectively instead of individually, and designated by reference numeral 212. Each user 212 can access or “log in” to document storage repository 206 using a workstation 220a-220n. The user 212 can then upload or download one or more documents into container files, whether such container files are accessible only by the user, shared among multiple users, or deliverable to one or more users. These workstations 220a-220n can include computer 20, a personal digital assistant (PDA), a palm computer, a mobile or wireless digital phone, multiple computers, combinations thereof, or the like, so long as the device used facilitates access to document storage repository 206.

Each workstation 220a-220n can include various application programs to facilitate user 212 accessing, viewing, and retrieving documents or container files stored at document storage repository 206. For example, each workstation 220a-220n can include a web browser to provide an interface through which user 212 can access or “log in” to document storage repository 206. Numerous web browsers are known to one skilled in the art, including but not limited to, Microsoft® Internet Explorer, Netscape® Navigator or Communicator, or the like. Further, each workstation 220a-220n can include application programs specific to the particular type of document stored at document storage repository 206. For instance, such application programs can include, but are not limited to, word processing applications, spreadsheet applications, and graphics applications.

In addition to using workstations 220a-220n, user 212 can employ one or more servers 222a-222n that optionally automatically create and deliver documents to document storage repository 206 or to container files within repository 206, and optionally retrieve documents from document storage repository 206 or from container files within repository 206. Consequently, servers 222a-222n can communicate with document storage repository 206 with or without the interaction of a human user to initiate such communication. This can be achieved, in one illustrative configuration, through use of an API that servers 222a-222n use to directly communicate with the hardware and software modules and components of document storage repository 206.

Access to document storage repository 206 is controlled by a control module 230. The control module 230, as implied by its name, manages the flow of data to and from document storage repository 206. Consequently, control module 230 can receive data from and deliver data to user 212. In one configuration, control module 230 includes a control application 232 to perform the above functions. The control application 232 can take the form of a web site with one or more web pages that provide a GUI that user 212 can employ to access document storage repository 206. Consequently, control module 230, in one embodiment, can include one or more web servers that host the above-described control application 232.

Generally, control application 232 can have various configurations so long as it is capable of controlling a user's access to the documents and container files stored within document storage repository 206. The control application 232, therefore, implements various user interfaces and functionality to achieve the various goals of the presently described invention. For instance, control application 232 can be responsible for setting up the structured storage used by each of the container files. One illustrative control application is the NetDocuments™ application provided by NetVoyage Corporation.

Other functionality of control application 232 can include aiding users in creating a user account that defines the access level and storage limits for each user 212. Consequently, the user accounts can define particular attributes and properties for each user 212. For instance, when a user account is created, user 212 can provide information about the user's name, address, telephone number, electronic mail message (e-mail), business trademark or logo that is presented to a viewer when a document or container file authored by the user is viewed by a user, document distributor designation, user ID, password, and the like. This information is stored within one or more user files 236a-236n in document storage repository 206 and defines each user as a unique individual or entity with specific properties, attributes, and characteristics. More specifically, the user account information, contained in user files 236a-236n can be stored in a directory module 234 communicating with control module 230.

In addition to the above, control application 232 can: (i) create and maintain one or more tracking logs; (ii) update some or all of the properties of individual documents and container files; (iii) place documents into and retrieve documents from a container file; (iv) perform security functions; (v) synchronize container files; (vi) transfer container files and/or documents from one user account to another user account, including transfer of documents from one container file to another container file, and so forth.

As mentioned above, control application 232 can insert documents into one or more container files and retrieve documents from these container files. In one embodiment, control application 232 can store a document retrieved from document distributor 202a-202n, free user 208a-208n, or fee-based user 210a-210n (FIG. 2) in a container file by obtaining the document and placing the document into the appropriate storage structure of the container file such as within a storage module 238. In one configuration, a user can access the web site hosted by control module 230 and through control application 232 and its GUI drag an icon representing a document to a location on the user interface representing a container file or its contents. Such an action can be a signal to control application 232 to obtain the identified document and place it into the identified container file.

Alternatively, a user can use an API to automatically insert a document into a container file or insert multiple copies of the same document into multiple container files, whether or not one or more of such container files are accessible by one user or multiple users. For instance, when document distributor 202a-202n is a utility company, service provider, or other business or individual wishing to deliver mass mailings, billing statements, and the like, document distributor 202a-202n can use the API to insert documents into container files of those users 212 desiring to receive such communication and information.

In a similar fashion to that described above, users can identify documents in a container file that should be removed from the container file. One skilled in the art will appreciate that other mechanisms can allow a user to identify a particular document that should be placed into or removed from a container file. Similarly, there are appropriate mechanisms for inserting and removing container files from a user's account or storage space designated within document storage repository 206.

The control module 230 and consequently control application 232 can communicate with directory module 234 to obtain user information and identify particular container files and documents associated with each user 212. Generally, directory module 234 can include lists of data associated with each user, such as a list of user objects or user files 236a-236n, which can be created as the user creates a user account. Also, directory module 234 can include a list of the specialized users termed “document distributors.” Although document storage repository 206 can store separate lists of general users and document distributors, it can be appreciated by one skilled in the art that a single list can be maintained with both general users and document distributors. Consequently, and reiterating, the term “user” can include both general users, i.e., fee users and free users, as well as document distributors.

The directory module 234 can take the form of a database of user information, such as but not limited to user names, addresses, telephone numbers, email addresses, and the like. As part of the present invention, directory module 234 can include a document distributor attribute for each user. The document distributor attribute identifies whether the user is or is not a document distributor and consequently identifies the availability of the above-recited rights and/or obligations. Further, once a user is designated as a document distributor, such as by the document distributor attribute having some value, each document or container file created by such a user is designated as being authored by a document distributor through inclusion of a free storage attribute that remains with the document or container file even if the document or container file is delivered or transferred to another user account or shared with one or more other users. Consequently, as those documents and/or container files are analyzed during resource allocation calculations, document storage repository 206 includes the number and/or size of the documents and/or container files that have such a free storage attribute in the document distributor's data storage total, while document storage repository 206 excludes such documents and container files from the recipient's data storage total, as will be discussed in greater detail hereinafter. In light of the teaching contained herein, one skilled in the art can identify various other manners to identify whether or not a user is a document distributor.

As discussed thus far, document storage repository 206 facilitates the storage of data that is uploaded from user 212, i.e., from workstations 220a-220n or servers 222a-222n. Optionally, document storage repository 206 can facilitate the delivery of documents from one user to another, i.e., from one container file to another container file. For instance, when multiple users work on a project that requires all users to have access to the same document, one user can create a container file containing the needed documents and allow each user working on the project to access the documents contained within the container file.

Generally, a storage module 238 stores documents and container files in a structured manner to allow efficient retrieval and updating of such documents and container files. The storage module 238 can have various configurations so long as it is capable of storing data in a manner that allows access and retrieval of the data as needed by control module 230. In the illustrated configuration, storage module 238 includes one or more container files 240a-240n and a worklist module 242.

As described above, each container file 240a-240n can store a wide variety of information. For example, each container file 240a-240n can be used to store one or more documents 244a-244n that are adapted for use by a specific application program. For instance, one of documents 244a-244n may be opened by a word processing application, while another one of documents 244a-244n may be opened by a spreadsheet application or graphics application. Various other types of document 244a-244n are known by those skilled in the art in light of the teaching contained herein.

In addition to documents 244a-244n, other information can also be stored in each container file 240a-240n. For instance, each container file 240a-240n can store a tracking log, such as a tracking log 246a-246n. Each tracking log 246a-246n can store information that allows actions performed on each container file 240a-240n and/or documents 244a-244n to be recorded. The tracking log 246a-246n provides a mechanism whereby changes and other actions performed by individuals or entities on a container file 240a-240n can be tracked and identified. This can provide important security features to container files 240a-240n, documents 244a-244n, and other information contained therein. By recording what actions were taken by which individuals, authorized actions taken by individuals can be identified.

Container files 240a-240n can also include various other types of information or data. This information is illustrated in FIG. 3 by properties 248a-248n. As explained in greater detail below, properties 248-248n represent information about documents 244a-244n or container file 240a-240n that is useful or desired. Such information can include, for example, the author of a particular document, summary information regarding a particular document, version information for the container file or a document, a free storage attribute for the container file or document, and so forth.

According to another aspect of the present invention, storage module 238 can include a worklist module 242. The worklist module 242 is configured to track those container files and documents stored in document storage repository 206 accessible by a user, i.e., which documents or container files are stored by the user either alone or in a user authored container file, in a shared container file accessible by the user, or the like. Consequently, worklist module 242 can include a list of users and those documents and container files accessible by those users. Optionally, worklist module 242 can include a list of all container files and documents with pointers to the user currently storing or otherwise having access to the same. The worklist module 242, and the information stored therein, is used when system 200 calculates the resource allocation of stored documents and container files within document storage repository 206, as will be described in detail hereinafter.

Generally, storage module 238 can take the form of any and all types of optically-read media, magnetically-read media, and the like. Further, storage module 238 can include flash memory, programmable EPROM, RAM, ROM, removable media, and the like. Although storage module 238 is shown as part of document storage repository 206, one skilled in the art will understand that storage module 238 need not be part of document storage repository 206, but can be remote from document storage repository 206 while being accessible by document storage repository 206.

In addition to control module 230 communicating with storage module 238 and directory module 234, control module 230 can communicate with resource allocation module 250. Resource allocation module 250 is adapted to calculate the amount of storage utilized by each user having an account with document storage repository 206. Further, resource allocation module 250 can optionally calculate a cost or bill for each user based upon their usage of the storage resources of document storage repository 206. Various types of modules, including conventional hardware and/or software components, are capable of calculating the storage used by each user.

As illustrated, intermediate between control module 230 and resource allocation module 250 is temporary file 252. Although temporary file 252 is illustrated as being separate from control module 230, one skilled in the art can appreciate that temporary file 252 can be incorporated within control module 230, resource allocation module 250, or in some other file or module of the present invention.

The temporary file 252 is adapted to temporarily store information related to the usage of document storage repository 206 by the various users. Temporary file 252 stores information about transactions performed by each user, i.e., how many documents were created by a user, to whom the documents were sent, the amount of storage being utilized by a user, and the like. This information can be collected for a defined period of time, such as a twenty-four hour period. Upon gathering the information for such a period of time, control module 230 delivers the information to resource allocation module 250. Alternatively, resource allocation module 250 can recognize the end of the time period and “pull” or import the information from temporary file 252. Consequently, the information stored in temporary file 252 can be pushed to or pulled from resource allocation module 250.

Various directory structures for document storage repository 206 and associated container files and documents are applicable for use with the present invention. For instance, as described in U.S. Pat. No. 6,182,080, the directory structure can be implemented using a wide variety of structure store technology, such as but not limited to, Microsoft Corporation's standard referred to as the OLE compound file standard, IBM Corporation and Apple Computer's standard referred to as OpenDoc, a JAVA standard called JAVA Beans, Novell Network NDS technology directory services, or other systems and standards known to one skilled in the art in light of the teaching contained herein. In addition, structured storage can be implemented using no particular standard at all, simply utilizing standard programming techniques to construct an appropriate structure storage mechanism. However, since utilizing an appropriate standard will make the result and the file more interoperable with other applications and programs, it may be desirable to utilize an appropriate standard.

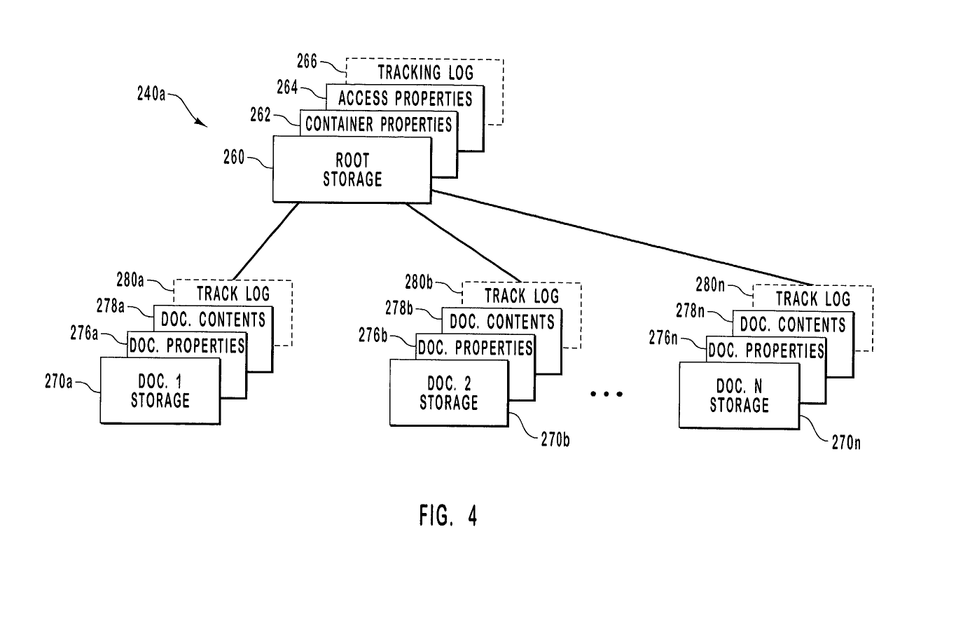

Referring now to FIG. 4, an illustrative representation of one storage structure of one embodiment of each container file 240a-240n is presented. The illustrative representation depicts only one container file 240a, however, it is understood that a similar discussion can be made for each container file 240a-240n. As illustrated, container file 240a has a root storage 260 that defines the storage structure of container file 240a. The root storage 260 can include streams, files, objects, or attributes that define various characteristics of container file 240a and the information stored in container file 240a. Exactly what information is stored will depend on the particular implementation.

As shown, container file 240a can include container properties 262, access properties 264 and a tracking log 266. Throughout this discussion, container properties 262, access properties 264, and tracking log 266 each will be identified as being stored as a single stream, file, object, or the like. However, such reference is made for notational convenience only. Container properties 262, as well as access properties 264 and tracking log 266, can be stored in more than one stream, file, object, or the like, depending upon the particular implementation of container file 240a. Optionally, in some configurations, container properties 262, access properties 264, and tracking log 266 can include numerous sub-files, sub-streams, sub-objects, sub-attributes, sub-properties, or the like.

The container properties 262 define the various attributes associated with container file 240a. Each of these attributes can have a fixed value, a true or false value, or a pointer to some other list stored in directory module 234, storage module 238, or the like. Numerous attributes are applicable for use as part of container properties 262. For instance, container properties 262 can include a list of the container's title or name, the date when container file 240a was created, a document distributor attribute designating whether the container file 240a was created by document distributor 202a-202n (FIG. 2), a free storage attribute identifying whether the container file and/or the documents therein should be included or excluded from the user's calculated storage total, the subject of container file 240a, the author or creator of container file 240a, key words describing container file 240a, a template field, a field indicating who was the last individual to save something in container file 240a, a revision number, total editing time, a last printed field describing when a document within container file 240a was last printed, a creation date/time field, a last saved date/time field, number of pages, number of words, number of characters, a thumbnail or summary field, the name of the application creating container file 240a, a security field, or the like. Note, that not all of these fields can be applicable to all implementations of container file 240a or the other container files of the present invention.

In addition to the above, container properties 262 can include information relating to the status of container file 240a, the location of the master copy of container file 240a, the modification sequence of container file 240a, a list of items which are synchronized or replicated between various copies of container file 240a, an indication of when container file 240a expires, routing information, mappings of various log information to user names, and a return address information displayed to a user in a graphical view of container file 240a.

Further, in some configurations, container properties 262 can contain user-defined properties. Consequently, a user can define properties that he or she wishes to track and maintain. These properties can then be stored as container properties 262 and retrieved for various purposes. In one embodiment, the user is allowed to dynamically create, modify, and delete properties and information stored in the properties.

The access properties 264 define the various users 212 (FIG. 3) that can access the documents and information stored within container file 240a. Specifically, access properties 264 can provide a list of those users 212, whether document distributors 202a-202n (FIG. 2), free users 208a-208n (FIG. 2), or fee-based users 210a-210n (FIG. 2) that can read, write, or otherwise manipulate the documents or data stored within container file 240a. Similarly, tracking log 266 stores a record of the individuals or entities that perform various actions on either container file 240a, the documents stored therein, stand alone documents not associated with container file 240a, combinations thereof, or the like.

Although the discussion herein has described separate properties forming part of container properties 262, access properties 264, and tracking log 266, one skilled in the art can appreciate that such properties can be stored in various other locations or distributed among the above-recited properties, logs or other similar files, streams, objects, or the like. For example, the properties described above with reference to container properties 262 can be included in access properties 264 and vice versa. Similarly, portions of those container properties 262 can be included in tracking log 266 and vice versa.

In a hierarchical relationship to root storage 260 is an individual storage for each of the documents that will be stored in container file 240a. In FIG. 4, three document storage locations are defined and these are labeled document 1 storage 270a, document 2 storage 270b, and document N storage 270n. As illustrated in FIG. 4, any number of document storages can be created and placed in container file 240a. Document storages 270a-270n each include document properties 276a-276n, document contents 278a-278n, and an optional tracking log 280a-280n. Each of document properties 276a-276n contains information relating to the individual documents stored in the respective storage 270a-270n. Although any useful or desired information can be stored in document properties 276a-276n, in one embodiment document properties 276a-276n include the document name. The document's name is the user name given to the document and the name by which the document is known to the user.

Further, document properties 276a-276n can include an author identifier, such as a document distributor attribute and/or a free storage attribute. These attributes identify whether or not a general user or document distributor creates the document.

The document properties 276a-276 can further include a default version number defining the current version of the document that is opened by default. Because multiple versions of each document can be stored, such as described in U.S. Pat. No. 6,181,080, it can be desirable to store a default version number so that application programs such as control application 232 (FIG. 3) know which version to retrieve by default when opening or editing a document.

In addition, document properties 276a-276n can include a global ID of the document. The global ID is a unique identifier given to each document to aid in matching documents in various copies of container files 240a-240n. A global ID is useful, for example, when trying to synchronize and resolve conflicts between two copies of a container file.

Further, the identity of the last user to save the document can be tracked and included as another attribute of document properties 276a-276n. Such an attribute can have a value or identify the last user to save the document. Similarly, the last saved date/time for the document can be stored within document properties 276a-276n.

In addition to the above, document properties 276a-276n can include a documents collision group. The document collision group is a property helpful in handling conflicts. For example, if different individuals change two copies of a document simultaneously, a conflict between the versions can exist. In this case, it can be possible to save both versions of the document and allow a user to sort it out. The document can then be identified as a member of a collision group until the conflict is resolved.

Another illustrative property of document properties 276a-276n is a document's tamper seal. The tamper seal is information that allows unauthorized access or tampering of the document to be recognized. For example, such a tamper seal can include a check sum or digital fingerprint of the information calculated according to some method which allows tampering of the document to be identified. In one embodiment the MD5 algorithm is used to generate a signature. If multiple versions are stored, a tamper seal for each version can be stored.

In addition to document properties 276a-276n, FIG. 4 illustrates that each document storage 270a-270n includes document contents 278a-278n. The document contents 278a-278n is the content to be displayed or otherwise accessed by user 212 (FIG. 3). For instance, when document storage 270a-270n is a word processing document, document contents 278a-278n include the words and optionally graphics that are displayed to the user when a document is accessed by way of a word processing application. Similarly, when document storage 270a-270n is a spreadsheet, document contents 278a-278n include the data, formulae, and the like to be inserted into each cell of the spreadsheet. Various types of document contents 278a-278n are applicable for use with the present invention and known to one skilled in the art in light of the teaching contained herein.

As illustrated in FIG. 4, each document storage 270a-270n can include an optional tracking log 280a-280n. As explained above, tracking log 266 stored at root storage 260 contains information regarding events that have occurred for all documents within container file 240a. However, storing a single large tracking log at the root storage level is not the only way to record and track events that occur to container file 240a or to documents 270a-270n within container file 240a. For example, each entry in a tracking log can include a wide variety of information.

The information tracked by tracking logs 266 and 280a-280n can include, for example, the identity of the individual taking the action, the action that occurred, the object of the action, the time that the action occurred, and the like. Organizing these entries can occur in a wide variety of ways. For instance, it can be desirable to organize the event entries by actions. As another example, it can be desirable to organize the event entries by identity of the user taking the action. As yet another example, the event entries can be organized by the target of the action. In such a situation, it can be desirable to maintain individual tracking logs for each of the various documents rather than one global tracking log for all entries. It can also be desirable to maintain some combination of the two.

As illustrated in FIG. 4, tracking logs 280a-280n are shown in dashed lines to indicate that such a log can be optional, depending upon the particular implementation selected. In addition, it may not be necessary to track global events and thus may not be necessary to maintain tracking log 266, depending on the particular implementation. In general, however, it is believed that it is important to track events that occur to the container file itself. In such an embodiment, it is desirable to store such events in a global tracking log such as tracking log 266.

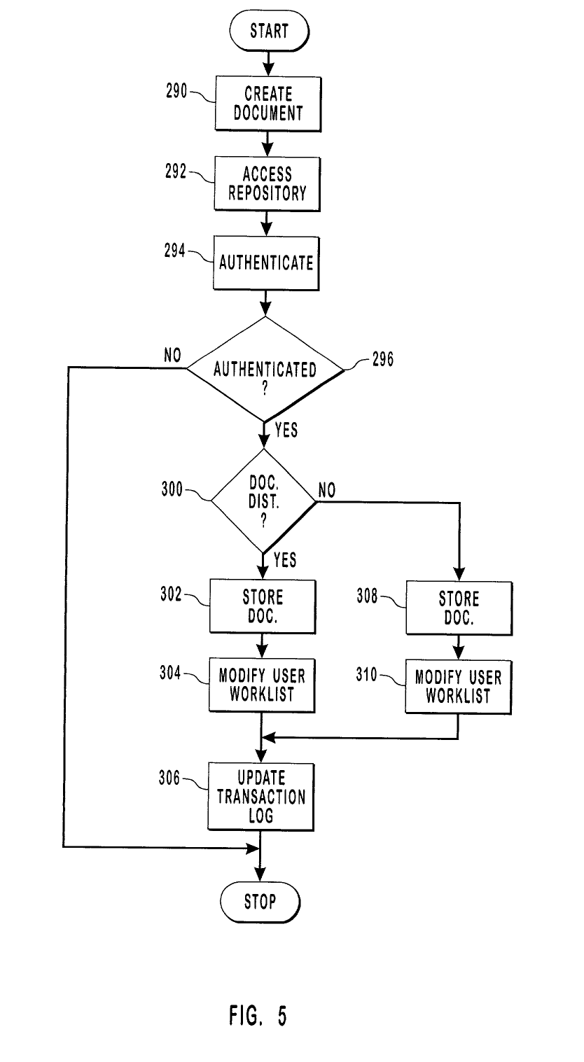

Referring now to FIG. 5, a flow diagram representing one illustrative manner by which documents are stored within document storage repository 206 is depicted. One skilled in the art can identify various other manners for storing documents within document storage repository 206. For instance, U.S. Pat. No. 6,181,080 discloses a manner to deliver documents to and from a document storage repository by various delivery transports, such as e-mail, or the like.

As shown in FIG. 5, a user begins by creating a document, as represented by block 290. The user can create the document employing one or more application programs, such as a word processing application, a spreadsheet application, a graphics application, and the like. Typically, user 212 (FIG. 3) can create a document and store the same upon a computer, such as computer 20 (FIG. 1).

Following creation of the document, the user can attempt to access document storage repository 206, as represented by block 292. As discussed above, this can include initiating a web browser on a workstation and connecting with a web site by inputting a uniform resource locator (URL) identifier. Alternatively, and more typically used by a document distributor, a server can directly communicate with document storage repository 206 (FIG. 3) by way of an API.

As part of the process to access document storage repository 206, the user is authenticated by document storage repository 206, as represented by block 294. In one configuration, the authentication process is required when the user accesses document storage repository 206 via a workstation or when a server attempts to automatically communicate with document storage repository 206. In the former case, such authentication can entail the user inputting a user name or ID and password into a graphical user interface associated with control application 232. In a similar manner, the server can upload an appropriate user name or ID and password to document storage repository 206 for authentication. One skilled in the art can identify various other manners for securely providing authentication data to document storage repository 206.

Once document storage repository 206 has received a user name and password, it verifies such information against the user information stored within directory module 234. Specifically, control module 230 compares the user name or ID and password against stored values for the appropriate user included in the lists of users in directory module 234. If the information received from the work station and/or server matches the information stored within directory module 234, the user is authenticated and allowed to access document storage repository 206. Alternatively, in the event the user is not authenticated, as represented by decision block 296 being in the negative, the user is denied access to document storage repository 206 and is unable to store the document or any other information therein or otherwise access any previously stored document or container file.

Upon authenticating the user, control module 230 identifies whether or not the user is a document distributor, as represented by decision block 300. In the event that the user is not a document distributor, control module 230 identifies the container files stored within storage module 238 that are accessible by the user. Consequently, control module 230 can present a graphical user interface that allows the user to drag and drop the particular document into a graphical representation of one or more of the container files associated with the user, as represented by block 308. Various options are provided depending on whether the user is a document distributor or not. In the event the user is not a document distributor, the user can store the document within the user's account or container file. Following such storage, the work lists stored in storage module 238 are updated to identify the document accessible by the specific user, as represented by block 310. Further, container file attributes can be modified, such as updating the date when the container file was last modified, the data stored therein, and the like. Following the storage of the document, the user can continue to access document storage repository 206 or alternatively disconnect or “log out” of document storage repository 206.

In the event that a user is a document distributor, as represented by decision block 300 being answered in the affirmative, control module 230 identifies the particular user that the document is to be delivered to and consequently stores the document in such a user's account, as represented by block 302. Optionally, the document distributor can automatically insert the document into a plurality of user accounts by defining an access list associated with the access properties of the document.

Substantially simultaneously with delivery of the document to the various users, or alternatively before or after delivery of the document and associated container file to one or more users, worklist module 242 is updated with information regarding to whom the document was delivered, the size of the document that was delivered, and/or the number of documents delivered to the various users, as represented by block 304. After updating worklist 242, the temporary transaction log is updated with information regarding the activities of the user, whether or not the user is a document distributor or a general user.

Although it is discussed above that a document distributor can automatically insert a document into another user's account, it is possible for other users to deliver documents to other users. While such an operation does not automatically insert the document into another user's account it does provide the functionality for sharing and delivering documents between various other users. For instance, in one configuration, a user can take the document they have created or have access to and insert the same into a container file deliverable to another user, i.e., a deliverable container file. This container file is then delivered to the recipient user that may access this container file and associated document(s). The delivering user, by delivering the container file and document(s) to the recipient relinquishes control of the container file and associated document(s). It is, however, possible for the delivering user to maintain control of the container file and document(s) by sharing the document(s) with other users via a shared container file. In this manner, the user can track the actions of other users as they use or manipulate the document(s) contained within the shared container file.

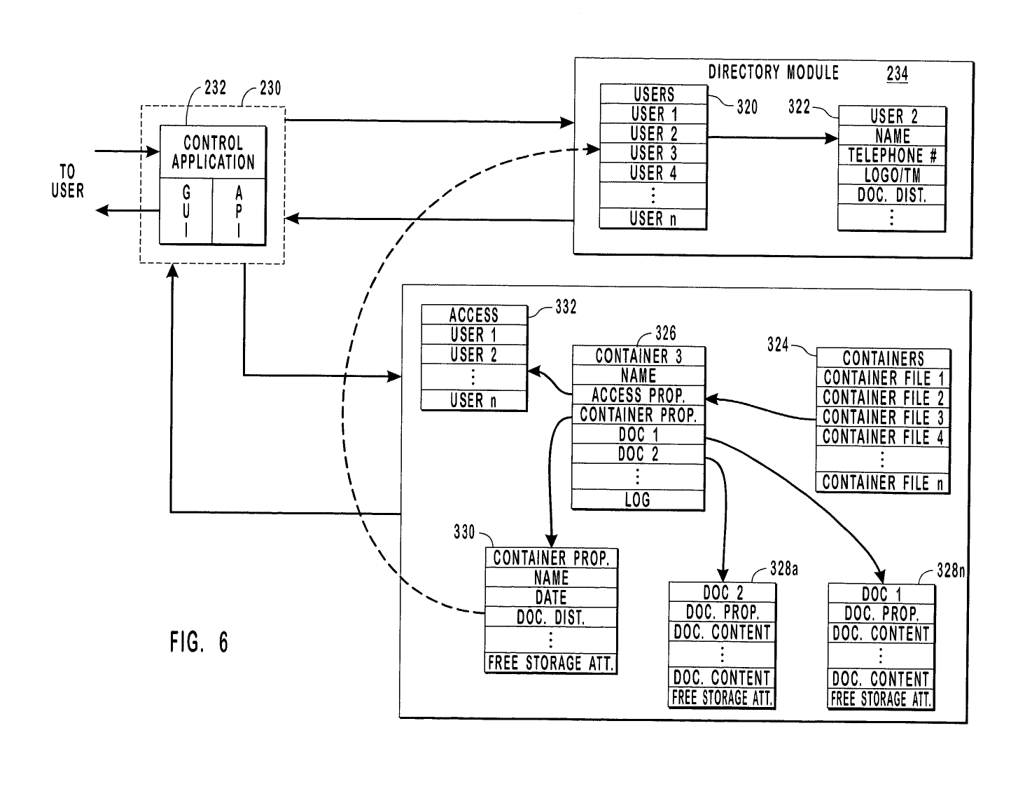

The above-described method is also schematically illustrated in FIG. 6, which represents the internal modules, components, attributes, and/or properties described above with respect to document storage repository 206 and the illustrative communication and linking therebetween. Although single modules, components, and attributes are depicted in FIG. 6, one skilled in the art can appreciate that multiple modules, components, and attributes can be included and are considered part of this invention. Similarly, the multiple modules, components, and attributes depicted in FIG. 6, can take the form of single modules, components, and attributes.

As discussed above, control application 232, whether the GUI or the API can receive requests for access to document storage repository 206. Following receipt of the access request, control application 232 communicates with directory module 234 and accesses information about the user accessing document storage repository 206. Specifically, control application 232 accesses a user list, designated by reference number 320. Upon accessing the user list, specific information about the user requesting access to document storage repository 206 is retrieved. For instance, let us assume that User 2 is requesting access to document storage repository 206. Consequently, control application 232 retrieves User 2 properties, designated by reference number 322, and compares the received user name or ID and password against the stored user name or ID and password. If they match, access is allowed, otherwise access to document storage repository 206 is denied. It should be understood that the user name/password authentication discussed herein is just one illustrative example of the type of authentication information that could be used in the present invention.

Following authentication, control application 232 and/or control module 230 can receive document(s), facilitate the exchange or delivery of documents and container files between one or more users, share documents and container files with multiple users, or the like. For instance, let us assume that the user wishes to insert a document into their user account, i.e., a container file designated for the users personal use, such as Container File 3. As shown in FIG. 6, as a user “logs in” to document storage repository 206, control application 232 and/or control module 230 retrieves the appropriate container file 326 from a container file list, designated by reference numeral 324. Such a container file could be, for example, Container File 3. Subsequently, the properties and other information related to Container File 3, as depicted by reference number 326, are retrieved so that Container File 3 or a graphical or textual representation of Container File 3 can be presented to the user through control application 232.

In the event that a user wishes to store a document, such as Document 1, the user can, in one configuration, drag an icon representation of Document 1 into the representation, whether textual and/or graphical, of the user's personal container file. Consequently, a document 328a-328n is created within Container File 3 and the document content and document properties are created, whether automatically by control application 232 and/or control module 230, manually by the user inputting information into the GUI presented to the user by control module 230, or a combination thereof.

These document properties can include a designation that the author of the document is a document distributor. This can be achieved through a document distributor attribute having a pointer to the particular user entry within directory module 234, or alternatively, through a document distributor attribute having a “true” or “false” value. Further, the document can include a free storage attribute that identifies that the document was created by a document distributor, while acting as a tag or notifying attribute that the amount of space used by the document is be excluded from the calculated storage total for the account within which the document is currently stored.

In addition, properties of Container File 3 can be updated to reference the inclusion of a new document, say document 328a-328n. Therefore, container properties 330 can be updated to reference a change to the content of the container file, identify who updated the container file, and the like. In a similar manner to document properties, container properties can include a designation that the author of the document is a document distributor by optionally including a document distributor attribute and/or a free storage attribute.

In some situations, the user, whether a document distributor or another user may wish to share the document stored within Container File 3 with other users. For instance, during a project an individual may wish to share multiple documents with a variety of individuals. To achieve this, the user can optionally modify the access properties 332 for Container File 3. The access properties 332 may define a list of one or more users that can access Container File 3. Therefore, any user listed in access properties 332 can retrieve or access the documents contained within Container File 3. Limited access can be provided based upon some restriction that might be referenced with respect to the access properties. For example, some users may be allowed to read or write to documents, while other users may only be allowed to read documents.

In an alternate configuration of the present invention, the user can share documents via a different manner. In such a case, the user can create another container file within which the user inserts or stores those documents to be shared between the various users. As before, the user defines the access properties to control the access to those documents. A similar process can be followed to access documents stored within a container file, such as Container File 3.

Further, as a user desires to view a container file and/or a document stored therein, control application 230 can retrieve logo and/or trademark information, if applicable, from the user that authored the container file and/or document. For example, say a document distributor authored a container file and/or documents included therein that is stored by a user. Upon accessing the container file and/or the documents, control application 232 identifies the author from the container properties and/or the document properties and retrieves the logo and/or trademark from the user account information associated with the document distributor. Control application 232 can subsequently display the logo and/or trademark to the user as they access the documents and/or container files authored by the document distributor. It can be appreciated by one skilled in the art that there are a number of different ways by which document distributor information can be presented to a user that accesses a container file and/or document authored by the document distributor.

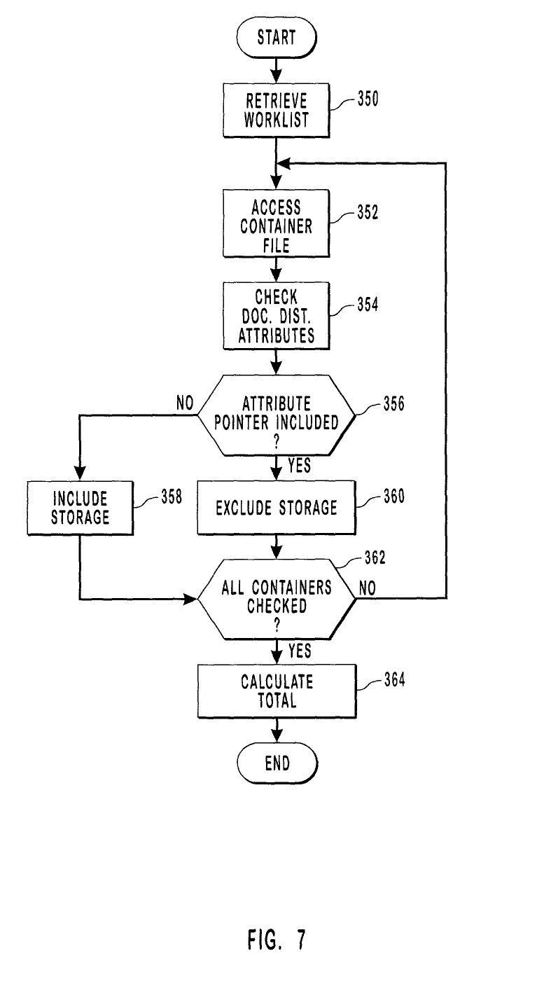

Referring now to FIG. 7, depicted is a flow diagram illustrating a method by which resource allocation analysis is performed according to one aspect of the present invention. This particular method is illustrative of one particular manner by which storage allocation information can be collected by document storage repository 206. The calculation of resources used can be performed at various times by control module 230 whether alone or in combination with resource allocation module 250 (FIG. 3). For instance, such resource allocation analysis may be performed continuously, periodically, in accordance with user defined instructions, a combination thereof, or the like.

Initially, control module 230 retrieves a worklist from worklist module 242 (FIG. 3) containing information about each user and those container files and/or documents accessible by the user, as represented by block 350. In one configuration, control module 230 and/or resource allocation module 250 retrieves the information from the worklist and the access information specific to each user. For instance, upon retrieving the worklist, control module 230 and/or resource allocation module 250 can identify each container file and/or document within a user's account that are accessible by the user. Further, control module 230 and/or resource allocation module 250 can access each container file and/or document, as represented by block 352.

As control module 230 and/or resource allocation module 250 accesses each container file and/or document, the value of the document distributor attribute or free storage attribute for the container file and/or document is retrieved, as represented by block 354. These attributes can be pointers, true or false values, or the like. It is understood by one skilled in the art, in light of the disclosure contained herein, that the designation of a container file, or for that matter a document, as authored by a document distributor can be performed in a variety of manners.

In the event that the document distributor attribute or the free storage attribute has a value, such as true, as represented by decision block 356, the storage total and/or the number of documents stored within the container file is excluded from the resource allocation total for the user that is currently storing the container file and/or documents, as represented by block 360. Alternatively, if the document distributor attribute or the free storage attribute is false or there is no value, the storage total and/or the number of documents stored within the container file is included in the resource allocation total for the user currently storing the container file and/or documents, as represented by block 358.

In another configuration, the document distributor attribute or the free storage attribute is a pointer to a particular user entry within directory module 234 (FIG. 3). Consequently, if the document distributor attribute or the free storage attribute includes a pointer, control module 230 and/or resource allocation module 250 tracks the pointer to the designated user and checks a corresponding document distributor attribute associated with the user's properties. In the event that such a document distributor attribute designates the user as a document distributor, the storage total and/or the number of documents stored within the container file and/or document that “pointed” to the document distributor is excluded from the resource allocation total for the user that is currently storing the container file and/or documents, as represented by block 360.

In contrast, in the event that the document distributor attribute for the “pointed to” user does not designate the user as a document distributor, the storage total and/or the number of documents stored within the container file are included in the resource allocation total for the user currently storing the container file and/or documents.

Stated in another way, if an entry in worklist module 242 (FIG. 3) that is currently being analyzed is for a first user, and if the first user is not a document distributor, but the documents and/or containers stored within the first user's account are authored by a document distributor, the total size and/or number of documents and/or container files stored within the first user's account that are authored by a document distributor are excluded from the first user's storage total. Consequently, this first user would not be allocated a usage total including the documents and container files received and authored by a document distributor. In contrast, the usage total for the corresponding document distributor would include the size and/or number of such documents and/or container files sent to the first user.

The above process continues until all the container files and/or documents within the worklists of worklist module 242 (FIG. 3) are checked, as depicted by decision block 362. Once all container files and/or documents within worklist module 242 (FIG. 3) are checked, the storage or usage total for each user is calculated, as represented by block 364.

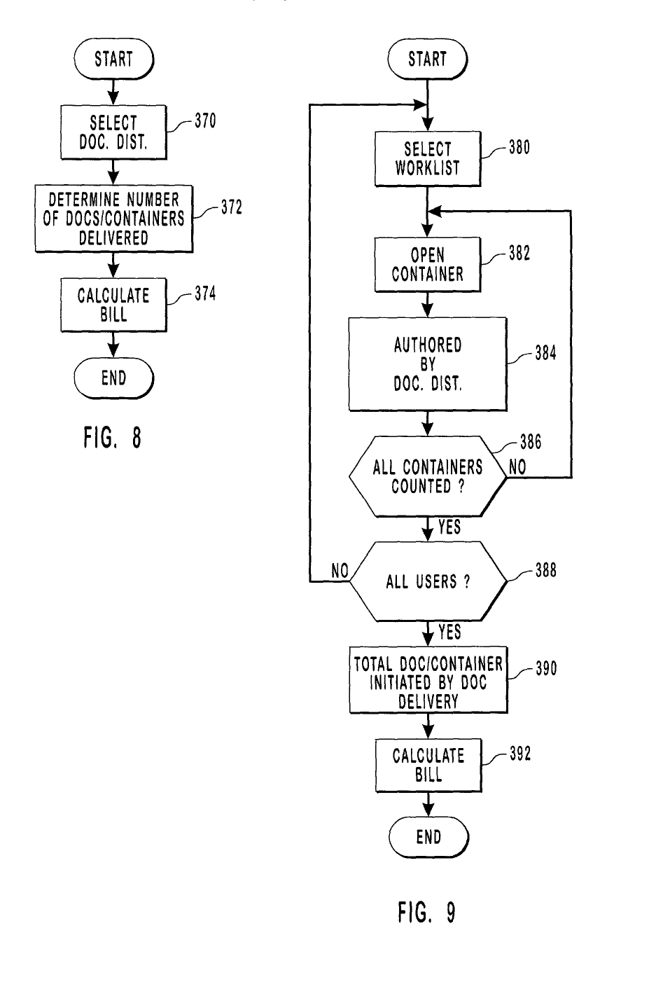

Referring now to FIG. 8, an alternative illustrative method by which storage resources are allocated and calculated is depicted. More specifically, the flow diagram of FIG. 8 illustrates a method by which bills can be calculated for storage usage by each document distributor where control module 230 and/or resource allocation module 250 has maintained an ongoing list of the number of documents and/or container files that each document distributor sends to other users. In this particular method, control module 230 (FIG. 3) optionally in combination with resource allocation module 250 selects a specific document distributor for which resource allocation is to be calculated. Following selection of the document distributor, as represented by block 370, the number of documents and/or container files delivered to other users is calculated, as represented by block 372. Specifically, resource allocation module 250 retrieves information stored within temporary file 252 and updates the data stored within resource allocation module 250. Resource allocation module 250 then identifies, by checking a tracking log stored within resource allocation module 250 the number of documents and/or container files delivered to other users.

Optionally, the calculation can include a determination of the total amount of storage allocated to a particular document distributor instead of identifying the number of documents and/or container files delivered to various users. Upon calculating the total number of documents, container files and/or amount of storage used, resource allocation module 250 can calculate an appropriate bill to be charged to the document distributor, as represented by block 374.

Referring now to FIG. 9, depicted is another illustrative method by which used storage capacity of document storage repository 206 can be allocated to a document distributor instead of the recipient that receives documents and/or container files from the document distributor. Specifically, a worklist for each user is opened, as represented by block 380. As discussed previously, each worklist of worklist module 242 (FIG. 3) represents the container files and documents that are accessible by a specific user, whether or not such documents are authored by the user, received by the user, shared by the user and other users, and the like. Once the worklist for a specific user is identified, each container file and/or document identified within the worklist is opened. Specifically, a container file and/or document is opened, as represented by block 382, and subsequently the container properties and optionally document properties for each document stored therein are checked to determine whether or not the container file and/or documents are authored by a document distributor, as depicted by block 384. This process is continued until all container files and/or documents specific to a user are identified and analyzed, as represented by decision block 386.

The process of opening the container files and/or documents and consequently determining whether or not the container file and/or document are authored by a document distributor continues until all users have been checked and verified, as represented by decision block 388. As each container file for a specific user is identified and determined to be from a document distributor, a running total of resources used by each document distributor is maintained. Following analysis of all users, a total for the number of documents delivered, the number of container files delivered, and/or the total storage usage by each document distributor, i.e., the total storage used by all documents delivered and all containers delivered to other users by the document distributor, is calculated as represented by block 390. Subsequently, a bill can be prepared, as represented by block 392, based upon the resources allocated to the document distributor and excluded from the users.

The present invention can be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired to be secured by United States Letters Patent is:

1. A method for tracking the allocation of resources within a document storage repository including a user account having a user storage total and a document distributor account having a document distributor storage total, the method comprising:
identifying a user account containing a document, the document comprising an attribute that defines an author of the document as a document distributor or a general user, and a storage amount defining the amount of the document storage repository used by the document;
analyzing the document to determine whether the attribute defines the author of the document as either a document distributor or a general user; and
in the event that the document distributor is the author, excluding the storage amount associated with the document from a user storage total and including the storage amount in a document distributor storage total.

2. A method as recited in claim 1, wherein the user account comprises at least one container file.

3. A method as recited in claim 1, wherein the document comprises a free storage attribute that identifies whether the storage amount is to be included or excluded from the user storage total.

4. A method as recited in claim 1, wherein the attribute comprises either a true value or a false value.

5. A method as recited in claim 1, wherein the attribute comprises a pointer to a list of user properties, the user properties comprising a document distributor attribute identifying a user as either a document distributor or a general user.

6. A method as recited in claim 5, wherein the inclusion of the document distributor attribute in the user properties identifies the user as a document distributor.

7. A method as recited in claim 1, further comprising calculating the document distributor storage total for the document distributor.

8. A method as recited in claim 1, further comprising:
identifying a user account for each user having a user account within the document storage repository;
analyzing each document stored within each user account to determine whether an attribute defines the author of each document as either the document distributor or the general user; and
calculating the document distributor storage total based upon substantially all the user accounts and substantially all the documents.

9. A method as recited in claim 1, wherein the user account comprises at least one container file comprising at least one document.

10. A method as recited in claim 9, wherein the container file comprises a container attribute that defines the author of the container file and the at least one document.

11. A method as recited in claim 10 further comprising:
identifying a user account for each user having a user account within the document storage repository;
analyzing each container file stored within each user account to determine whether the container attribute defines the author of the container file and the at least one document stored therein as either the document distributor or the general user; and
calculating the document distributor storage total based upon substantially all the user accounts and substantially all the container files.

12. A method for tracking the allocation of resources of at least one container file associated with at least one user and determining a storage total for the at least one user, the method comprising:
identifying at least one container file that includes at least one document, the at least one container file comprising an attribute defining authorship of the at least one container file, and a storage amount defining the size of the at least one container file and the at least one document;
analyzing the at least one container file to determine whether the attribute is either a first entry or a second entry, the second entry indicating that the at least one container file is authored by a document distributor; and
in the event that the attribute is set to the second entry, excluding the storage total associated with the at least one container file in the storage total associated with the user.

13. A method as recited in claim 12, wherein in the event that the attribute is set to the first entry, including the storage total associated with the at least one container file in a storage total associated with the user.

14. A method as recited in claim 12, wherein the attribute defines the authorship of the at least one container file and the at least one document stored therein.

15. A method as recited in claim 12, wherein an at least one document attribute defines the authorship for the at least one document.

16. A method as recited in claim 12, wherein the first entry is a false value and the second entry is a true value.

17. A method as recited in claim 12, wherein the second entry is a pointer to a stored document distributor attribute, the document distributor attribute designating the user as a document distributor.

18. A method as recited in claim 12, wherein the first entry is zero.

19. A method as recited in claim 12, further comprising:
identifying a user account within a document storage repository for at least one user, each user account comprising at least one container file;
analyzing the at least one container file stored within each user account to determine whether each attribute comprises the first entry or the second entry; and
calculating a document distributor storage total based upon substantially all the user accounts and substantially all the container files.

20. A method for tracking a storage total representative of the amount of storage within a data repository used by a document distributor, the method comprising:
identifying at least one container file in a data repository associated with a user, the at least one container file comprising a plurality of documents, each of the plurality of documents comprising:
an attribute defining the author of the document as either a document distributor or a general user; and
a storage value defining the size of the document;
analyzing each of the plurality of documents to identify which of the plurality of documents is authored by a document distributor; and
calculating a storage total for the document distributor by summing the storage total for each document of the plurality of documents within each container file that is authored by the document distributor.

21. A method as recited in claim 20, wherein at least one container file is stored within a plurality of user accounts associated with a plurality of users.

22. A method as recited in claim 21, wherein the step of analyzing comprises analyzing each of the plurality of documents within each of the plurality of user accounts.

23. A method as recited in claim 20, wherein the step of analyzing comprises analyzing a set of document properties associated with each of the plurality of documents, the set of document properties comprising a free storage attribute.

24. A method as recited in claim 20, wherein the step of analyzing comprises analyzing a set of container properties associated with the at least one container file, the set of container properties comprising a free storage attribute.

25. A method as recited in claim 24, wherein the at least one container file comprises a container storage total.

26. A method as recited in claim 25, wherein the step of calculating comprises summing each container storage total for each container file having the free storage attribute.

27. A method as recited in claim 25, wherein the step of calculating comprises summing the number of container files comprising the free storage attribute.

28. A method as recited in claim 20, wherein the attribute is a free storage attribute.

29. A method as recited in claim 27, wherein the step of calculating comprises summing the number of the plurality of documents comprising a free storage attribute.

30. A computer program product for implementing, in a system that includes at least one processor and a data repository, a method for tracking a storage total representative of the amount of storage within the data repository used by a document distributor, the computer program product comprising:
a computer readable medium carrying computer-executable instructions for implementing the method, wherein the computer-executable instructions, when executed by the processor, cause the system to perform the acts of:
identifying at least one container file in the data repository associated with a user, the at least one container file comprising a plurality of documents, each of the plurality of documents comprising:
an attribute defining the author of the document as either a document distributor or a general user; and
a storage value defining the size of the document;
analyzing each of the plurality of documents to identify which of the plurality of documents is authored by a document distributor; and
calculating a storage total for the document distributor by summing the storage total for each document of the plurality of documents within each container file that is authored by the document distributor.

31. A computer program product for implementing, in a system that includes at least one processor and a data repository, a method for tracking the allocation of resources within a document storage repository containing a user account having a user storage total and a document distributor account having a document distributor storage total, the computer program product comprising:
a computer readable medium carrying computer-executable instructions for implementing the method, wherein the computer-executable instructions, when executed by the processor, cause the system to perform the acts of:
identifying a user account containing a document, the document comprising an attribute that defines an author of the document as a document distributor or a general user, and a storage amount defining the amount of the document storage repository used by the document;
analyzing the document to determine whether the attribute defines the author of the document as either a document distributor or a general user; and
in the event that the document distributor is the author, excluding the storage amount associated with the document from a user storage total and including the storage amount in a document distributor storage total.

32. A computer program product for implementing, in a system that includes a processor and a data repository, a method for tracking the allocation of resources within a document storage repository containing a user account having a user storage total and a document distributor account having a document distributor storage total, the computer program product comprising:
a computer readable medium carrying computer-executable instructions for implementing the method, wherein the computer-executable instructions comprise:
program code means for identifying a user account containing a document, the document comprising an attribute that defines an author of the document as a document distributor or a general user, and a storage amount defining the amount of the document storage repository used by the document;
program code means for analyzing the document to determine whether the attribute defines the author of the document as either a document distributor or a general user; and
in the event that the document distributor is the author, program code means for excluding the storage amount associated with the document from a user storage total and including the storage amount in a document distributor storage total.

33. A computer-readable medium having a plurality of data fields stored on the medium and representing a data structure comprising:
a first data field containing data representative of at least one of a container file and a document;
a second data field derived from the first data field by identifying an author of at least one of the container file and the document;
a third data field derived from the first data field by calculating a storage size of at least one of the container file and the document; and
a forth data field functioning to identify the author of at least one of the container file and the document as either a document distributor or a general user, wherein in the event that the forth data field identifies the author as the document distributor, adding the storage size of at least one of the container file and the document to the storage total of the document distributor.
